(19) United States
(12) Patent Application Publication
(10) Pub. No.: US 2008/0141832 A1
(43) Pub. Date: Jun. 19, 2008

(54) RATCHET WITH SUBSTANTIALLY SILENT MOVEMENT-PREVENTION MECHANISM

(76) Inventor: Don W. Phillips, Beavercreek, OR (US)

Correspondence Address: DAVID P. COOPER;Kolisch Hartwell, P.C., 200 Pacific Building, 520 S.W. Yamhill Street, Portland, OR, 97204, US

(21) Appl. No.: 12/040,190

(22) Filed: Feb. 29, 2008

Related U.S. Application Data
(63) Continuation of application No. 11/736,287, filed on Apr. 17, 2007, now abandoned.
Application No. 11/736,287 is a continuation of application No. 11/521,817, filed on Sep. 15, 2006, now abandoned.
Application No. 11/521,817 is a continuation of application No. 11/204,906, filed on Aug. 15, 2005, now abandoned.
Application No. 11/204,906 is a continuation of application No. 10/644,972, filed on Aug. 19, 2003, now abandoned.
(60) Provisional application No. 60/404,572, filed on Aug. 19, 2002.

(51) Int. Cl. B25B 13/46

(52) U.S. Cl. 81/60

(57) ABSTRACT

A ratchet with a handle and a head that includes a substantially silent movement-prevention mechanism. The mechanism includes a first component that defines a path, and a second component that is locatable in the path and moves bidirectionally within it. The path is constructed to include plural regions that prevent movement by the second component to allow the ratchet to drive a desired fastener. The first component is constructed to define a path, or plural paths, with a central region that allows movement of the second component and outer, opposing regions that prevent movement of the second component. The second component is formed as a roller or plural rollers. The central region of the path includes a subregion constructed to position the second component in a beginning location in the central region. The subregion may be formed as a depression in the path.

### CROSS REFERENCE TO RELATED APPLICATIONS

This application is a continuation of U.S. patent application Ser. No. 11/736,287, filed Apr. 17, 2007 and entitled “Ratchet with Substantially Silent Movement-Prevention Mechanism”, which is a continuation of U.S. patent application Ser. No. 11/521,817, filed Sep. 15, 2006 and entitled “Ratchet with Substantially Silent Movement-Prevention Mechanism”, which is a continuation of U.S. patent application Ser. No. 11/204,906, filed Aug. 15, 2005 and entitled “Ratchet with Substantially Silent Movement-Prevention Mechanism”, which is a continuation of U.S. patent application Ser. No. 10/644,972, filed Aug. 19, 2003 and entitled “Ratchet with Substantially Silent Movement-Prevention Mechanism”, which claims priority to U.S. Provisional Application Ser. No. 60/404,572, filed Aug. 19, 2002 and entitled “Ratchet”. The subject matter of the above-identified applications are incorporated herein by reference.

### TECHNICAL FIELD

The present invention relates generally to ratchets, and more particularly to a ratchet that includes an improved, substantially silent mechanism for stopping reversal of motion.

### BACKGROUND ART

Conventional ratchet tools are constructed with a bar or wheel with teeth that are engaged by a pawl to prevent reversal of motion. As a result, a conventional ratchet tool can be rotated freely in a first direction (no engagement of the pawl) while being stopped from rotation in a second opposite direction. This type of mechanism is useful to tighten fasteners such as a bolt. The ratchet engages the bolt head and the user can rotate the ratchet in one direction freely without driving the bolt head. However, when rotating the ratchet in a second, opposite direction, the ratchet does not rotate freely and drives the bolt head.

Drawbacks with conventional ratchets include an undesirable clicking sound when the ratchet is rotated in the first, non-bolt-head-driving direction. In addition, conventional pawl mechanisms have certain structural limits wherein they fail if a certain level of force is applied to the ratchet during operation.

Accordingly, it would be useful to provide a ratchet with a substantially silent movement-prevention mechanism when the ratchet is used to drive a fastener. A general object of the present invention is to provide such a mechanism for a ratchet. More specifically, objects of the invention include to provide such a mechanism that can be: (1) used without producing a clicking sound during operation; (2) incorporated into various ratchet designs; (3) used to withstand the highest levels of force that can be applied manually to a ratchet; and (4) incorporated into ratchet designs in a cost-effective way.

### SUMMARY OF THE INVENTION

The invention may be characterized as a substantially silent movement-prevention mechanism for a ratchet. Put another way, the invention may be characterized as a ratchet with a handle and a head that includes a substantially silent movement-prevention mechanism. The mechanism includes a first component that defines a path, and a second component that is locatable in the path and moves bidirectionally within it. The path is constructed to include plural regions that prevent movement by the second component to allow the ratchet to drive a desired fastener. The first component is constructed to define a path, or plural paths, with a central region that allows movement of the second component and outer, opposing regions that prevent movement of the second component. The second component is formed as a roller or plural rollers. The central region of the path includes a subregion constructed to position the second component in a beginning location in the central region. The subregion may be formed as a depression in the path.

Various features and other objects and advantages which are attained by the invention will become more fully apparent after consideration of the accompanying drawings and the detailed description of the preferred embodiment which follows.

### BRIEF DESCRIPTION OF THE DRAWINGS

FIG. 1 is an isometric view of a ratchet constructed with a substantially silent movement-prevention mechanism made in accordance with an embodiment of the present invention.

FIG. 2 is an exploded side view of the ratchet taken along lines 2-2 in FIG. 1 (after rotating the ratchet about 180° so that the head is at the right of the page and the handle is at the left of the page) except that the fastener-driver attachment has been removed.

FIG. 3 is an enlarged, fragmentary, top, sectional view of the ratchet head of FIG. 1 taken along lines 3-3 and showing the movement-prevention mechanism of the invention.

FIG. 4 is a further enlarged (relative to FIG. 3) view of certain details of the movement-prevention mechanism shown in FIG. 3.

FIG. 5 is a further enlarged (relative to FIG. 4) view of certain details of the movement-prevention mechanism shown in FIG. 3.

FIGS. 6-8 are further enlarged, fragmentary, top, sectional views of versions of a ratchet head like that shown in FIG. 3, depicting how components move during operation of the ratchet.

FIG. 9 is an enlarged, exaggerated view of the area of FIG. 7 encircled by circle 9, showing how distortion of mechanism components occurs (see arrows) when maximum force is applied.

### DETAILED DESCRIPTION OF PREFERRED EMBODIMENT AND BEST MODE OF CARRYING OUT THE INVENTION

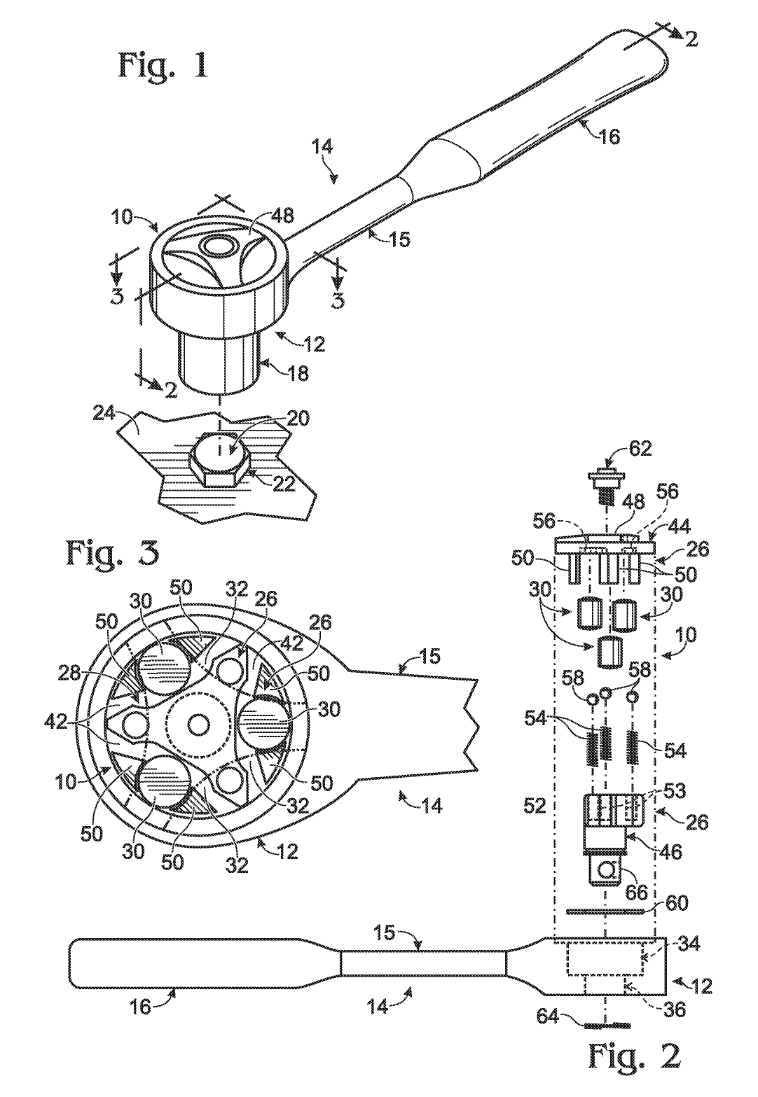

Referring to FIG. 1, the invention is shown generally at 10 as a movement-prevention mechanism built in a head 12 of a ratchet 14 with a shaft 15 and a handle 16. Ratchet 14 is fitted with a suitable fastener-driver attachment for driving or tightening a fastener such as bolt 20 with bolt head 22 into surface 24

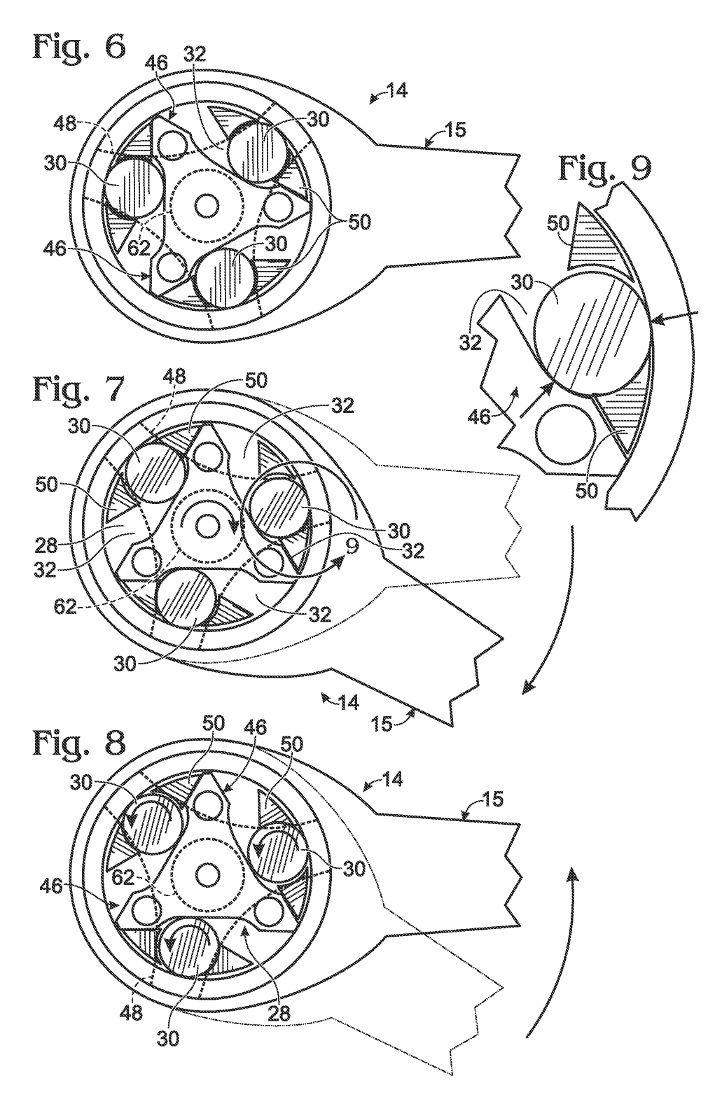

Referring to FIGS. 2-3, mechanism 10 is shown in further detail including a first component 26 that defines path structure 28, and a second component 30 that is locatable in path structure 28 and movable bidirectionally therein (refer ahead to FIGS. 6-8). Path structure 28 is constructed to include a region 32 that prevents movement by second component 30 to allow ratchet 14 to drive a desired fastener (like bolt 20 in FIG. 1). First and second components 26, 30 are fitted into a first opening 34 formed in ratchet head 12. Fastener-driver attachment 18 (FIG. 1) fits into a second opening 36 also formed in ratchet head 12.

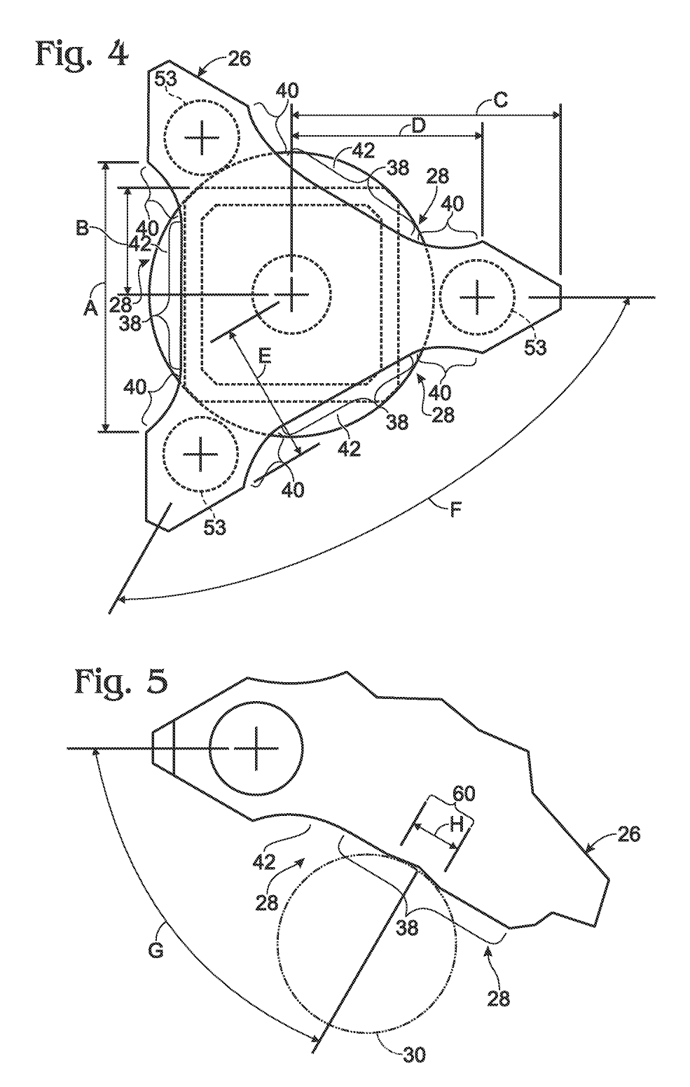

Referring to FIGS. 4-5, first component 26 is constructed to define path structure 28 with a central region 38 that allows movement of second component 30 and an outer region 40 that prevents movement of second component 30. As depicted, outer region 40 is preferably formed as opposing outer regions. Referring to FIGS. 3-5, first component 26 is constructed to define plural paths 42, with each path having central region 38 that allows movement of second component 30 and opposing outer regions 40 that prevent movement of second component 30. Also as depicted, second component 30 may be formed as a roller or plural rollers, and any reference herein to 30 in the drawings may be viewed either as the second component of mechanism 10 or as a roller.

Referring back to FIG. 2, first component 26 is formed as first and second subcomponents 44, 46 that together locate the rollers in desired paths (see, for e.g., FIG. 3). As will be shown in connection with the description of FIGS. 6-8, first subcomponent 44 is constructed to direct each roller to move in a desired direction from a beginning location in central region 38 by rotating actuator 48 of first subcomponent 44. First subcomponent 44 is also constructed with pairs of opposing legs 50 that are positioned at opposing sides of each roller 30 (see, for e.g., FIG. 3).

Still referring to FIG. 2, second sub-component 46 includes a top section 52 with plural recesses 53 formed in it to house springs 54, and first sub-component 44 is formed with recesses 56 for receiving part of balls 58. By forming first and second subcomponents 44 and 46 in this way the two can be joined to maximize their cooperation in locating rollers 30 and defining paths 42. Ultimately, first and second subcomponents 44, 46 are positioned in recess 34 on washer 60 and held together via a suitable fastening system such as bolt 62 and retainer ring 64 that encircles bottom section 66 of second component 46.

Referring to FIG. 5, central region 38 includes a subregion 68 constructed to position the second component in a beginning location in central region 38. This beginning location may also be thought of as a pre-loaded position for each roller 30. As shown, subregion 68 is formed as a depression, preferably having a depth of about 0.005-0.007 inches (following the same tolerances as noted in the table below).

Tight tolerances are required to achieve the best results with the invention, and dimensions that have been found acceptable are shown below and refer to the letter references shown in FIGS. 4-5 (tolerances are as follows: within 0.1 inch for dimensions with one decimal place; within 0.01 inches for dimensions with two decimal places; within 0.005 inches for dimensions with three decimal places; within 30′ for angular dimensions; within 1/32 inches for fractional dimensions; and finish requirements of 32 microns):

| Letter Reference | Dimension (inches unless specified) |
|---|---|
| A | .470-.475 |
| B | .189-.190 |
| C | .464-.466 |
| D | .318-.323 |
| E | .245-.250 |
| F | 120° |
| G | 60° |
| H | .070-.075 |

Any suitable material can be used to construct ratchet 14 and mechanism 10, but the presently preferred materials are as follows: 01 tool steel for second component 46 (also referred to herein as a triangle component); 5160 steel for handle 16; 52100 steel for rollers 30; and GS51 plastic (including 30% glass fibers) for first component 44. In addition, all screws, springs and detents/recesses are preferably made from stainless steel. To form the above-described mechanism components from steel, suitable machining techniques should be used including heat treatment of second component 44 and rollers 30 to provide elasticity.

By using the above materials and forming the above components, ratchets made according to the invention have been used to meet the accepted ANSI standard of being able to pull 165 ft. lbs. as compared to conventional ratchets whose maximum capability is 60-70 ft. lbs. before failing.

Referring to FIGS. 6-8, operation of ratchet 14 with mechanism 10 is shown, with FIG. 6 showing what happens when the user turns knob 48 clockwise to move roller 30 from its beginning (pre-loaded position resting in depression 68. Next, referring to FIG. 7, the user moves the ratchet in a drive stroke in the direction of the downward arrow and mechanism 10 performs its function of preventing movement of rollers 30 so that the ratchet can be used to turn a fastener such as bolt 20 at the remarkably high psi range of 180-225 psi without failing/slipping. FIG. 9 shows in an exaggerated view that rollers 30, such as the depicted roller, distort under the user's turning force when mechanism 10 prevents further movement. Referring back to FIG. 8, the user performs a return stroke in the direction of the upward arrow to return the ratchet to the beginning position (FIG. 6) and the ratchet action can be repeated to tighten a fastener such as a bolt.

The basic idea in operation is that there is not a true neutral to a ratchet made with the mechanism of the invention. The pre-loaded position is the starting point for engagement, and then turning of the knob causes the ratchet to be locked for clockwise or counterclockwise driving of a fastener such as a bolt.

The disclosure set forth above encompasses multiple distinct embodiments of the invention. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

I claim:

1. A substantially silent movement-prevention mechanism for a ratchet, comprising:
a first component that defines path structure;
a second component that is locatable in the path structure and movable bidirectionally therein; and
wherein the path structure is constructed to include a region that prevents movement by the second component to allow the ratchet to drive a desired fastener.

2. The mechanism of claim 1, wherein the first component is constructed to define path structure with a central region that allows movement of the second component and an outer region that prevents movement of the second component.

3. The mechanism of claim 2, wherein the path structure includes opposing outer regions that prevent movement of the second component.

4. The mechanism of claim 2, wherein the path structure is constructed as plural paths, with each path having a central region that allows movement of the second component and an outer region that prevents movement of the second component.

5. The mechanism of claim 3, wherein the path structure is constructed to define plural paths, with each path having a central region that allows movement of the second component and an outer region that prevents movement of the second component.

6. The mechanism of claim 4, wherein the second component is formed as plural rollers.

7. The mechanism of claim 6, wherein the first component is formed as first and second subcomponents that together locate the rollers in desired paths.

8. The mechanism of claim 2, wherein the central region includes a subregion constructed to position the second component in a beginning location in the central region.

9. The mechanism of claim 8, wherein the subregion is formed as a depression in the path structure.

10. The mechanism of claim 6, wherein the central region includes a subregion constructed to position the second component in a beginning location in the central region.

11. A ratchet, comprising:
a handle; and
a head that is constructed with a substantially silent movement-prevention mechanism that includes a first component that defines path structure, and a second component that is locatable in the path structure and movable bidirectionally therein; and
wherein the path structure is constructed to include a region that prevents movement by the second component to allow the ratchet to drive a desired fastener.

12. The ratchet of claim 11, wherein the first component is constructed to define path structure with a central region that allows movement of the second component and an outer region that prevents movement of the second component.

13. The ratchet of claim 12, wherein the path structure includes opposing outer regions that prevent movement of the second component.

14. The ratchet of claim 12, wherein the path structure is constructed to define plural paths, with each path having a central region that allows movement of the second component and an outer region that prevents movement of the second component.

15. The ratchet of claim 13, wherein the path structure is constructed to define plural paths, with each path having a central region that allows movement of the second component and an outer region that prevents movement of the second component.

16. The ratchet of claim 11, wherein the second component is formed as a roller.

17. The ratchet of claim 11, wherein the second component is formed as plural rollers.
